(19) United States
(12) Patent Application Publication
(10) Pub. No.: US 2002/0042250 A1
(43) Pub. Date: Apr. 11, 2002

(54) Wireless communication device with selective power supply function

(75) Inventor: Kiyoshi Tamukai, Tokyo (JP)

Correspondence Address: YOUNG & THOMPSON, 745 SOUTH 23RD STREET 2ND FLOOR, ARLINGTON, VA, 22202

(73) Assignee: NEC Corporation

(21) Appl. No.: 09/968,989

(22) Filed: Oct. 3, 2001

(30) Foreign Application Priority Data
Oct. 11, 2000 (JP) 2000-311227

(51) Int. Cl. H04B 7/00

(52) U.S. Cl. 455/69; 455/70; 455/522

(57) ABSTRACT

The present invention provides a wire-less communication device including: a main circuit capable of at least one operation of writing, reading and erasing data, and browsing and displaying informations as well hearing voice informations; a radio unit having at least a first function block of transmitting a radio wave; and a power supply selector electrically coupled to the radio unit and the main circuit separately, wherein, in a first operational mode, the power supply selector supplies a power to both the radio unit and the main circuit, so as to place the radio unit and the main circuit in operable-state, and wherein, in a second operational mode, the power supply selector inhibits a power supply to at least the first function block of the radio unit, so as to place at least the first function block of the radio unit in inoperable-state and place the main circuit in operable-state.

### BACKGROUND OF THE INVENTION

1. Field of the Invention

The present invention relates to a wire-less communication device, and more particularly to an improved wireless mobile terminal device such as a wireless mobile telephone.

2. Description of the Related Art

One of the serious issues with wireless mobile terminals or wireless mobile telephones is an influence of a radio wave transmitted therefrom to any electric, electronic or electron devices, for example, electric or electronic medical instruments, pacemakers, and electric or electronic aircraft instruments. In general, the use of wireless mobile terminals or wireless mobile telephones emitting or transmitting the radio wave is inhibited in hospitals, airplanes and other radio-wave-transmission inhibited areas. The wireless mobile telephone in power-ON state is capable of automatically transmitting the radio wave upon receipt of a call, for which reason it is required to place the mobile telephone into power-OFF state in radio-wave-emission inhibited areas.

In general, advanced mobile telephones accommodate memories for storing any data such as telephone numbers for automatic dialing to send a call to another telephone and further storing other useful informations to be displayed and/or browsed. Upon sending a call to another telephone and receiving a call from another telephone, the radio wave is emitted or transmitted from the wireless mobile telephone. However, displaying and browsing the useful informations on the wireless mobile telephone and hearing the voice informations are available without emitting the radio wave from the wireless mobile telephone. Other operations of writing, reading and erasing data such as telephone numbers are also available without emitting the radio wave from the wireless mobile telephone.

The conventional wireless mobile telephone is, however, capable of displaying and browsing the useful informations, hearing the voice informations and of other operations of writing, reading and erasing data such as telephone numbers but only when the wireless mobile telephone is placed in the power-ON state, where the conventional wireless mobile telephone may automatically emit or transmit the radio wave upon unpredictable receipt of a call from another telephone. In the radio-wave-emission inhibited areas such as hospitals and airplanes, it is necessary to keep the wireless mobile telephone in the power-OFF state, wherein the wireless mobile telephone is incapable of displaying and browsing the useful informations and also of other operations of writing, reading and erasing data such as telephone numbers.

In the above circumstances, the development of a novel wireless mobile terminal device free from the above problems is desirable.

### SUMMARY OF THE INVENTION

Accordingly, it is an object of the present invention to provide a novel wireless mobile terminal device free from the above problems.

It is a further object of the present invention to provide a novel wireless mobile terminal device capable of displaying and browsing informations or data stored in an integrated or non-integrated memory, and hearing the voice informations stored in the integrated or non-integrated memory and also other operations of writing, reading and erasing data such as telephone numbers through accesses to the integrated or non-integrated memory not only in a power-ON state but also in a power-OFF state.

It is a still further object of the present invention to provide a novel wireless mobile telephone free from the above problems.

It is yet a further object of the present invention to provide a novel wireless mobile telephone capable of displaying and browsing informations or data stored in an integrated or non-integrated memory and hearing the voice informations stored in the integrated or non-integrated memory and also other operations of writing, reading and erasing data such as telephone numbers through accesses to the integrated or non-integrated memory not only in a power-ON state but also in a power-OFF state.

It is further more object of the present invention to provide a novel wireless mobile telephone electrically connectable to a wired telephone for transmitting telephone number data to the wired telephone for dialing the wired telephone based on the telephone number data even if the wireless mobile telephone is placed in a power-OFF state.

It is an additional object of the present invention to provide a novel wire-less communication device free from the above problems.

It is a further additional object of the present invention to provide a novel wire-less communication device capable of at least one of displaying and browsing informations or data stored in an integrated or non-integrated memory, and hearing the voice information stored in the integrated or non-integrated memory and also other operations of writing, reading and erasing data such as telephone numbers through accesses to the integrated or non-integrated memory not only in a power-ON state but also in a power-OFF state.

It is further more object of the present invention to provide a novel wire-less communication device electrically connectable to a wired external device for transmitting particular data to the wired external device for operating the wired external device based on the transmitted data even if the wireless mobile telephone is placed in a power-OFF state.

The present invention provides a wire-less communication device including: a main circuit capable of at least one operation of writing, reading and erasing data, and browsing and displaying informations as well as hearing voice informations; a radio unit having at least a first function block of transmitting a radio wave; and a power supply selector electrically coupled to the radio unit and the main circuit separately, wherein, in a first operational mode, the power supply selector supplies a power to both the radio unit and the main circuit, so as to place the radio unit and the main circuit in operable-state, and wherein, in a second operational mode, the power supply selector inhibits a power supply to at least the first function block of the radio unit, so as to place at least the first function block of the radio unit in inoperable-state and place the main circuit in operable-state.

The above and other objects, features and advantages of the present invention will be apparent from the following descriptions.

### BRIEF DESCRIPTION OF THE DRAWINGS

Preferred embodiments according to the present invention will be described in detail with reference to the accompanying drawings.

FIG. 1 is a block diagram illustrative of an internal structure of a wireless mobile telephone in a preferred embodiment in accordance with the present invention.

FIG. 2 is a flow chart illustrative of one example of operations of the wireless mobile telephone of FIG. 1.

FIG. 3 is a block diagram illustrative of an internal structure of a modified novel wire-less mobile telephone in accordance with the present invention.

### DETAILED DESCRIPTIONS OF THE PRESENT INVENTION

A first aspect of the present invention is a wire-less communication device including: a main circuit capable of at least one operation of writing, reading and erasing data, and browsing and displaying informations as well as hearing voice informations; a radio unit having at least a first function block of transmitting a radio wave; and a power supply selector electrically coupled to the radio unit and the main circuit separately, wherein, in a first operational mode, the power supply selector supplies a power to both the radio unit and the main circuit, so as to place the radio unit and the main circuit in operable-state, and wherein, in a second operational mode, the power supply selector inhibits a power supply to at least the first function block of the radio unit, so as to place at least the first function block of the radio unit in inoperable-state and place the main circuit in operable-state.

It is preferable that the main circuit includes a control unit electrically coupled to the power supply selector for sending the power supply selector a first-mode control signal in the first operational mode so as to supply the power to both the radio unit and the main circuit, and sending the power supply selector a second-mode control signal in the second operational mode so as to inhibit the power supply to at least the first function block of the radio unit.

It is further preferable that the power supply selector is electrically connected through a first power supply line to at least the first function block of the radio unit, and also the power supply selector is electrically connected through a second power supply line to the main circuit, and in the first operational mode, the power supply selector supplies the power on both the first and second power supply lines and in the second operational mode, the power supply selector supplies the power on the second power supply line only.

It is also preferable that the radio unit further has a second function block for switching channels and a third function block for receiving the radio wave, and in the second operational mode, the power supply selector further inhibits the power supply to the second function block in addition to the first function block, so as to place at least both the first and second function blocks in inoperable state.

It is further preferable that the main circuit includes a control unit electrically coupled to the power supply selector for sending the power supply selector a first-mode control signal in the first operational mode so as to supply the power to both the radio unit and the main circuit, and sending the power supply selector a second-mode control signal in the second operational mode so as to inhibit the power supply to at least the first and second function blocks of the radio unit.

It is further more preferable that the power supply selector is electrically connected through a first power supply line to at least the first and second function blocks of the radio unit, and also the power supply selector is electrically connected through a second power supply line to the main circuit, and in the first operational mode, the power supply selector supplies the power on both the first and second power supply lines and in the second operational mode, the power supply selector supplies the power on the second power supply line only.

It is also preferable that in the second operational mode, the power supply selector furthermore inhibits the power supply to the third function block in addition to the first and second function blocks, so as to place at least all the first, second and third function blocks in inoperable state.

It is further more preferable that the main circuit includes a control unit electrically coupled to the power supply selector for sending the power supply selector a first-mode control signal in the first operational mode so as to supply the power to both the radio unit and the main circuit, and sending the power supply selector a second-mode control signal in the second operational mode so as to inhibit the power supply to all of the first, second and third function blocks of the radio unit.

It is moreover preferable that the power supply selector is electrically connected through a first power supply line to at least the first, second and third function blocks of the radio unit, and also the power supply selector is electrically connected through a second power supply line to the main circuit, and in the first operational mode, the power supply selector supplies the power on both the first and second power supply lines and in the second operational mode, the power supply selector supplies the power on the second power supply line only.

It is also preferable that the radio unit is electrically coupled to an antenna.

It is also preferable that the main circuit includes: a control unit electrically coupled to the power supply selector for sending the power supply selector a first-mode control signal in the first operational mode so as to supply the power to both the radio unit and the main circuit, and sending the power supply selector a second-mode control signal in the second operational mode so as to inhibit the power supply to at least the first function block of the radio unit; a memory electrically coupled to the control unit and also electrically connected through the second power supply line to the power supply selector, so that any access to the memory is permitted in both the first and second operational states; and a display unit electrically coupled to the control unit and also electrically connected through the second power supply line to the power supply selector, so that any display of information and/or data is permitted in both the first and second operational states.

It is further preferable that the main circuit further includes: a clock signal oscillator electrically coupled to the radio unit and the control unit for supplying a clock signal, and the clock signal oscillator being also connected through the second power supply line to the power supply selector for receiving the power from the power supply selector in both the first and second operational states.

It is preferable to further comprise a connector electrically coupled to the control unit, and the connector being electrically connectable with a wired external device for allowing data transmission through the connector to the wired external device.

It is preferable to further comprise a connector electrically coupled to the main circuit, and the connector being electrically connectable with a wired external device for allowing data transmission through the connector to the wired external device.

It is also preferable that the wire-less communication device comprises a wire-less mobile terminal having an antenna which is electrically coupled to the radio unit for transmitting a radio wave from the antenna only in the first operational mode.

It is further preferable that the wire-less mobile terminal comprises a wire-less mobile telephone.

It is preferable to further comprise a connector port electrically coupled to the main circuit, and the connector port being electrically connectable with a wired telephone for allowing data transmission through the connector port to the wired telephone.

It is preferable that the data include at least a telephone number, so that the wired telephone displays the telephone number.

A second aspect of the present invention is a wire-less communication device including: a main circuit capable of at least one operation of writing, reading and erasing data, and browsing and displaying informations as well as hearing voice informations; a radio unit operable for at least transmitting and receiving a radio wave; and a power supply selector electrically coupled to the radio unit and the main circuit separately, wherein, in a first operational mode, the power supply selector supplies a power to both the radio unit and the main circuit, so as to place the radio unit and the main circuit in operable-state, and wherein, in a second operational mode, the power supply selector inhibits a power supply to the radio unit, so as to place the radio unit in inoperable-state and place the main circuit in operable-state.

It is preferable that the main circuit includes a control unit electrically coupled to the power supply selector for sending the power supply selector a first-mode control signal in the first operational mode so as to supply the power to both the radio unit and the main circuit, and sending the power supply selector a second-mode control signal in the second operational mode so as to inhibit the power supply to the radio unit.

It is also preferable that the radio unit is electrically coupled to an antenna.

It is also preferable that the main circuit includes: a control unit electrically coupled to the power supply selector for sending the power supply selector a first-mode control signal in the first operational mode so as to supply the power to both the radio unit and the main circuit, and sending the power supply selector a second-mode control signal in the second operational mode so as to inhibit the power supply to the radio unit; a memory electrically coupled to the control unit and also electrically connected through the second power supply line to the power supply selector, so that any access to the memory is permitted in both the first and second operational states; and a display unit electrically coupled to the control unit and also electrically connected through the second power supply line to the power supply selector, so that any display of information and/or data is permitted in both the first and second operational states.

It is further preferable that the main circuit further includes: a clock signal oscillator electrically coupled to the radio unit and the control unit for supplying a clock signal, and the clock signal oscillator being also connected through the second power supply line to the power supply selector for receiving the power from the power supply selector in both the first and second operational states.

It is also preferable to further comprise a connector electrically coupled to the control unit, and the connector being electrically connectable with a wired external device for allowing data transmission through the connector to the wired external device.

It is also preferable to further comprise a connector electrically coupled to the main circuit, and the connector being electrically connectable with a wired external device for allowing data transmission through the connector to the wired external device.

It is also preferable that the wire-less communication device comprises a wire-less mobile terminal having an antenna which is electrically coupled to the radio unit for transmitting a radio wave from the antenna only in the first operational mode.

It is further preferable that the wire-less mobile terminal comprises a wire-less mobile telephone.

It is moreover preferable to further comprise a connector port electrically coupled to the main circuit, and the connector port being electrically connectable with a wired telephone for allowing data transmission through the connector port to the wired telephone.

It is also preferable that the data include at least a telephone number, so that the wired telephone displays the telephone number.

A third aspect of the present invention is a wire-less mobile terminal device including: at least a memory for storing data; a display unit for displaying any data or information; a control unit electrically coupled to the memory and the display unit; a radio unit electrically coupled to an antenna for transmitting and receiving a radio-wave, and the radio unit being also electrically coupled to the control unit; and a power supply selector electrically connected through a first power supply line to the radio unit and electrically connected through a second power supply line to the control unit, the display unit, and the memory, and also the power supply selector electrically connected through a control signal line to the control unit, wherein, in a first operational mode, the control unit supplies a first-mode control signal to the power supply selector, so that the power supply selector supplies a power onto both the first and second power supply lines so as to place the radio unit, the control unit, the display unit, and the memory in operable-state, and wherein, in a second operational mode, the control unit supplies a second-mode control signal to the power supply selector, so that the power supply selector supplies the power onto only the second power supply line so as to place the control unit, the display unit, and the memory in operable-state, and place the radio unit in inoperable-state.

It is preferable to further include: a clock signal oscillator electrically coupled to the radio unit and the control unit for supplying a clock signal, and the clock signal oscillator being also connected through the second power supply line to the power supply selector for receiving the power from the power supply selector in both the first and second operational states.

It is preferable to further comprise a connector electrically coupled to the control unit, and the connector being electrically connectable with a wired external device for allowing data transmission through the connector to the wired external device.

It is also preferable that the wire-less mobile terminal comprises a wire-less mobile telephone. It is preferable to further comprise a connector port electrically coupled to the control unit, and the connector port being electrically connectable with a wired telephone for allowing data transmission through the connector port to the wired telephone. It is preferable that the data include at least a telephone number, so that the wired telephone displays the telephone number.

### Preferred Embodiment

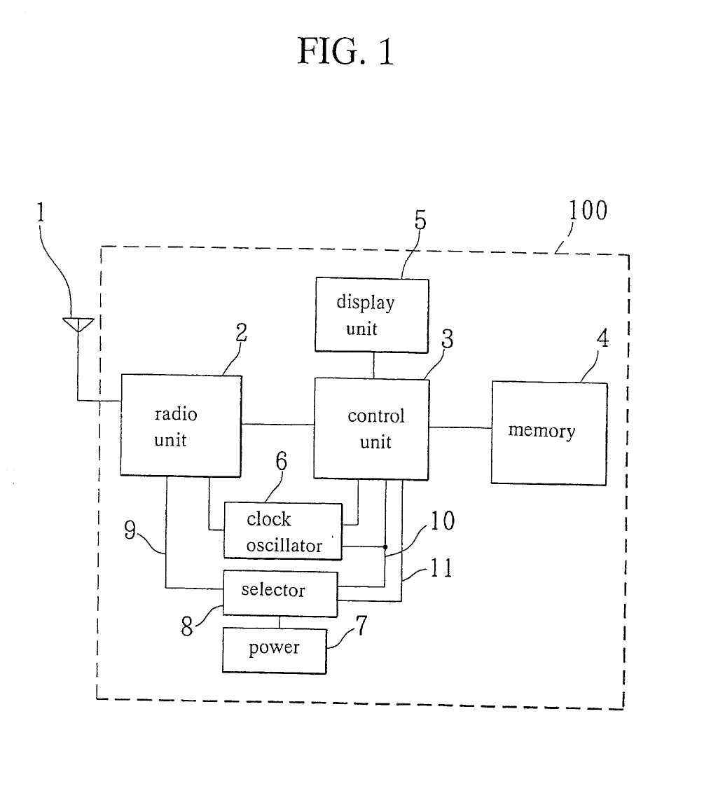

A preferred embodiment according to the present invention will be described in detail with reference to the drawings. FIG. 1 is a block diagram illustrative of an internal structure of a wireless mobile telephone in a preferred embodiment in accordance with the present invention. A wireless mobile telephone 100 includes an antenna 1 for transmitting radio waves to a base station and receiving radio waves transmitted from the base station. The wireless mobile telephone 100 also includes a radio unit 2 electrically coupled to the antenna 1 for receiving input radio signals from the antenna 1, so that the radio unit 2 performs processings of the input radio signals, for example, amplification and demodulation of the input signals to generate internal signals. The wireless mobile telephone 100 also includes a control unit 3 electrically coupled to the radio unit 2 for receiving the internal signal from the radio unit 2. The radio unit 2 receives an internal signal from the control unit 3 for modulation and amplification of the internal signal to generate an output radio signal. This radio signal is supplied to the antenna 1 for transmitting a radio wave to the base station.

The wireless mobile telephone 100 also includes a memory 4 electrically coupled to the control unit 3 for reading and writing data such as telephone numbers and any useful informations through accesses to the memory 4 under the control by the control unit 3.

The wireless mobile telephone 100 also includes a display unit 5 electrically coupled to the control unit 3 for displaying the informations or the data such as the telephone numbers under the control by the control unit 3.

The wireless mobile telephone 100 is placed in a radio wave transmitting mode or a radio wave receiving mode under the control by the control unit 3. The wireless mobile telephone 100 further includes a clock signal oscillator 6 electrically coupled to the radio unit 2 and the control unit 3 for supplying a clock signal to the radio unit 2 and the control unit 3.

A power supply 7 is electrically coupled through a power supply selector 8. The power supply 7 may accommodate a battery. The power supply selector 8 is electrically connected through a first power supply line 9 to the radio unit 2. The power supply selector 8 is also electrically connected through a second power supply line 10 to the control unit 3, the clock oscillator 6, the display unit 5 and the memory 4 and any other elements than the radio unit 2. The power supply selector 8 is also connected through a power supply control signal line 11 to the control unit 3 for receiving a power supply control signal from the control unit 3, so that the power supply selector 8 separately allows a first power supply through the first power supply line 9 to the radio unit 2, and a second power supply through the second power supply line 10 to the control unit 3, the clock oscillator 6, the display unit 5 and the memory 4 and any other elements than the radio unit 2.

Optionally, a voice signal as an analog signal from a microphone not illustrated is transmitted to the radio unit 2 for modulation based on the voice signal to generate a modulated voice signal as a digital signal. The radio unit 2 also demodulates the digital voice signal to generate a voice signal as an analog signal for subsequently transmitting the analog voice signal to a speaker not illustrated. Those operations are made under the control by the control unit 3.

The above mobile telephone 100 has two different operational modes, for example, a telephone-operable mode and a telephone-inoperable mode.

In the telephone-operable mode, the wireless mobile telephone 100 is permitted to perform all functions including normal telephone functions, for example, transmitting and receiving the radio wave through the antenna 1 and further any data processings, for example, displaying data on the display unit 5, wiring data into the memory 4, and reading and erasing the data from the memory 4 as well as browsing the informations stored in the memory 4 and hearing the voice informations stored in the memory 4. In this telephone-operable mode, the control unit 3 supplies a first-mode power control signal through the power control line 11 to the power supply selector 8, so that the power supply selector 8 allows both the first power supply through the first power supply line 9 to the radio unit 2, and the second power supply through the second power supply line 10 to the control unit 3, the clock oscillator 6 and any other elements than the radio unit 2, whereby the mobile telephone 100 is operable both as the wire-less mobile telephone and as the data processor for writing, reading and erasing data or informations and browsing the stored informations or data. Namely, in this mode, the operations of the wireless mobile telephone 100 are the same as the conventional wireless mobile telephone.

In the telephone-inoperable mode, the wireless mobile telephone 100 is permitted to perform partial functions but only of the data processings, for example, displaying data on the display unit 5, wiring data into the memory 4, and reading and erasing the data from the memory 4 as well as browsing the informations stored in the memory 4. Namely, in this telephone-inoperable mode, the wireless mobile telephone 100 is inhibited to transmit or emit the radio wave from the antenna 1 for performing the wireless telephone function.

In this telephone-inoperable mode, the control unit 3 supplies a second-mode power control signal through the power control line 11 to the power supply selector 8, so that the power supply selector 8 inhibits the first power supply through the first power supply line 9 to the radio unit 2, but allows only the second power supply through the second power supply line 10 to the control unit 3, the clock oscillator 6 and any other elements than the radio unit 2, whereby the radio unit 2 is placed in inoperable state, wherein the radio unit 2 does not perform the demodulation and modulation operations and also amplification operation. As a result, the wireless mobile telephone 100 is incapable of emitting or transmitting the radio wave. Namely, the wireless mobile telephone 100 is inoperable as the wireless mobile telephone but operable for the data processings, for example, displaying data on the display unit 5, wiring data into the memory 4, and reading and erasing the data from the memory 4 as well as browsing the informations stored in the memory 4 and hearing the voice information stored in the memory.

It is possible that the radio unit 2 includes three function blocks, for example, a first function block operable in transmitting the radio wave, a second function block operable in switching the channels, and a third functional block operable in receiving the radio wave. In order to suppress the radio wave transmission, it is necessary to inhibit the power supply to at least the first function block operable in transmitting the radio wave. It is preferable to inhibit the power supply to at least both the first function block operable in transmitting the radio wave and the second function block operable in switching the channels. It is, of course, possible to inhibit the power supply to all the first, second and third function blocks.

In view of the above, in this telephone-inoperable mode, the control unit 3 supplies the second-mode power control signal through the power control line 11 to the power supply selector 8, so that the power supply selector 8 inhibits the first power supply through the first power supply line 9 to at least the first function block of the radio unit 2, and preferable to both the first and second function blocks of the radio unit 2, and, of course, possibly to all the first, second and third function blocks of the radio unit 2.

Thus, it is necessary that the first power supply line 9 is connected to at least the first function block of the radio unit 2. In the telephone-inoperable mode, the power supply selector 8 inhibits the first power supply through the first power supply line 9, so that no power is supplied to at least the first function block of the radio unit 2, whereby the first function block of the radio unit 2 is inoperable, and the radio unit 2 is inoperable for transmitting the radio wave.

It is also preferable that the first power supply line 9 is connected to the first and second function blocks of the radio unit 2. In the telephone-inoperable mode, the power supply selector 8 inhibits the first power supply through the first power supply line 9, so that no power is supplied to the first and second function blocks of the radio unit 2, whereby the first and second function blocks of the radio unit 2 are inoperable, and the radio unit 2 is inoperable for transmitting the radio wave and switching the channel.

It is, of course, possible that the first power supply line 9 is connected to all the first, second and third function blocks of the radio unit 2. In the telephone-inoperable mode, the power supply selector 8 inhibits the first power supply through the first power supply line 9, so that no power is supplied to all the first, second and third function blocks of the radio unit 2, whereby all the first, second and third function blocks of the radio unit 2 are inoperable, and the radio unit 2 is inoperable for transmitting the radio wave, switching the channel and receiving the radio wave.

The above two different operational modes may be switched by operation of the user. When the above wireless mobile telephone moves to enter into the radio-wave-transmission inhibited area, then the user may operate the above wireless mobile telephone to place the same into the telephone-inoperable mode without power-OFF operation. Any measures for switching the wireless mobile telephone between the telephone-operable mode and the telephone-inoperable mode may be available. For example, the wireless mobile telephone has a power key (power push button), function keys (function push buttons), number keys (number push buttons) and a send key (send push button). The above switching operations between the two modes may be made by operating the keys, for example, concurrent pushing the power key and any other key such as a function key.

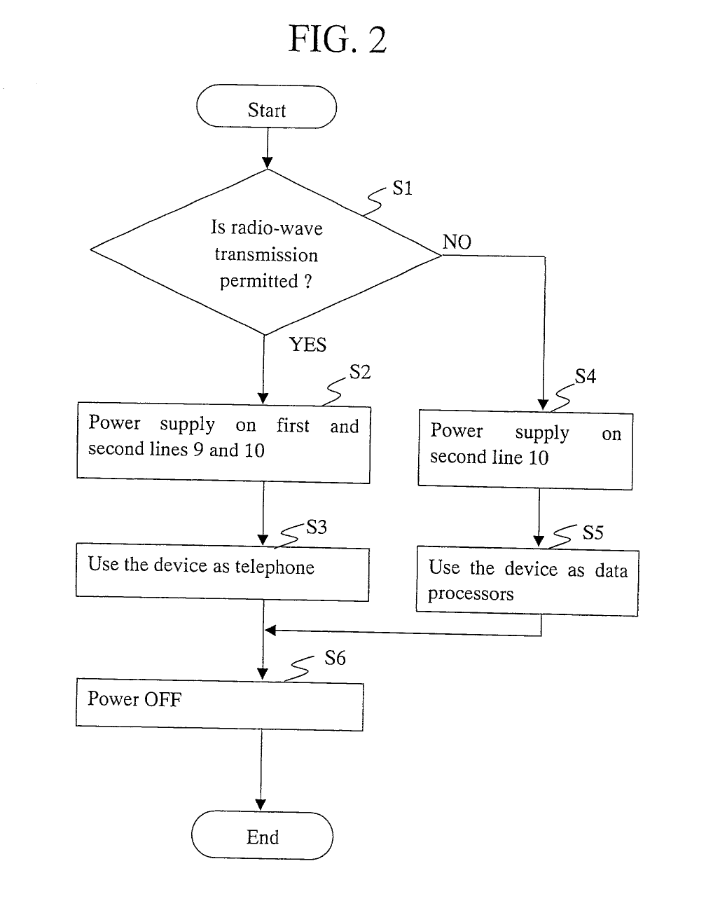

FIG. 2 is a flow chart illustrative of one example of operations of the wireless mobile telephone of FIG. 1. In a step S1, the user confirms here is the radio-wave-transmission-inhibited area or the permitted area. If the radio-wave-transmission-permitted area, in steps S2 and S3, the user operates the keys to place the wireless mobile telephone in the above telephone-operable mode, wherein the power is supplied to both the first and second power supply lines 9 and 10, whereby the wireless mobile telephone is operable as telephone and further any data processings, for example, displaying data on the display unit 5, wiring data into the memory 4, and reading and erasing the data from the memory 4 as well as browsing the informations stored in the memory 4 and hearing the voice informations stored in the memory 4. If the radio-wave-transmission-inhibited area, in steps S4 and S5, the user operates the keys to place the wireless mobile telephone in the above telephone-inoperable mode, wherein the power is supplied to only the second power supply line 10, whereby the wireless mobile telephone is inoperable as telephone but operable as any data processings, for example, displaying data on the display unit 5, wiring data into the memory 4, and reading and erasing the data from the memory 4 as well as browsing the informations stored in the memory 4 and hearing the voice informations stored in the memory 4. If the telephone function and also the above data processing functions become unnecessary, then the user may place the wireless mobile telephone into power-OFF state by usual operation, for example, pushing the power key.

As described above, in the above radio-wave-transmission-inhibited area, the novel wire-less mobile telephone is permitted to be kept in power-ON state, but in the above telephone-inoperable state. The wire-less mobile telephone is, of course, inoperable as the telephone, but operable for data processings, for example, displaying data on the display unit 5, wiring data into the memory 4, and reading and erasing the data from the memory 4 as well as browsing the informations stored in the memory 4 and hearing the voice information.

The above novel wire-less mobile telephone is, as described above, unable to call another telephone in the telephone-inoperable mode. It is, however, possible to modify the above novel wire-less mobile telephone to enable the novel wire-less mobile telephone in the telephone-inoperable mode to send a call through a wired telephone in the radio-wave-transmission inhibited area to a target telephone located at another area.

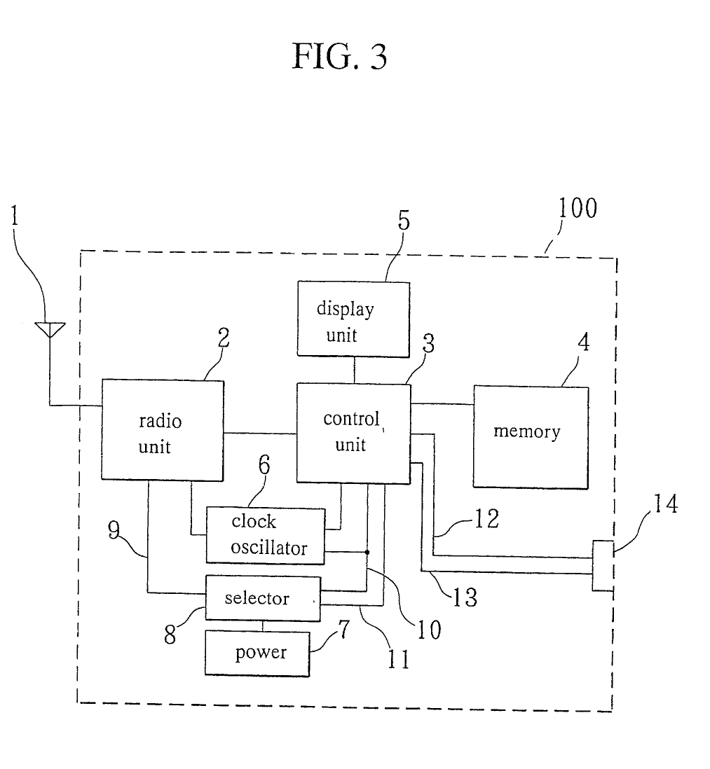

FIG. 3 is a block diagram illustrative of an internal structure of a modified novel wire-less mobile telephone in accordance with the present invention. A structural difference of the modified novel wire-less mobile telephone of FIG. 3 from the above novel wire-less mobile telephone of FIG. 1 is only in further providing a connector port for electrically coupling the modified novel wire-less mobile telephone to a wired telephone located in the radio-wave-transmission-inhibited area. As illustrated in FIG. 3, the modified novel wire-less mobile telephone 100 has a connector port 14 which is connected to the control unit 3 through a connect-detecting line 12 and a display data transmission line 13. Other structure of the modified novel wire-less mobile telephone 100 of FIG. 3 is the same as the novel wire-less mobile telephone of FIG. 1.

The following descriptions will focus on the above structural difference. The modified novel wire-less mobile telephone 100 is connectable via the connector port 14 to a wired telephone, for example, a public telephone. When the modified novel wire-less mobile telephone 100 become connected to the wired telephone, a connect-detecting signal is entered from the wired telephone and transmitted through the connector port 14 and the connect-detecting line 12 to the control unit 3, wherein the connect-detecting signal indicates that the modified novel wire-less mobile telephone 100 become connected to the wired telephone.

Upon receipt of the connect-detecting signal through the connect-detecting line 12, the control unit 3 transmits the second-mode power control signal through the power control line 11 to the power supply selector 8, so that the power supply selector 8 inhibits the first power supply through the first power supply line 9 to the radio unit 2, but allows only the second power supply through the second power supply line 10 to the control unit 3, the clock oscillator 6 and any other elements than the radio unit 2, whereby the radio unit 2 is placed in inoperable state, wherein the radio unit 2 does not perform the demodulation and modulation operations and also amplification operation.

As a result, the modified wireless mobile telephone 100 is incapable of emitting or transmitting the radio wave. Namely, the modified wireless mobile telephone 100 is inoperable as the wire-less mobile telephone but operable for transmitting a display data through the display data transmission line 13 and the connector port 14 to the wired telephone, whereby the wired telephone displays the transmitted data, for example, information about the target telephone number.

In detail, upon receipt of the connect-detecting signal through the connect-detecting line 12, the control unit 3 has an access to the memory 4 for reading the display data including the target telephone number from the memory 4. The control unit 3 then transmits the display data including the target telephone number through the display data transmission line 13 and through the connector port 14 to the wired telephone, whereby the wired telephone automatically displays the target telephone number on the display unit. The user may operate the wired telephone for dialing the target telephone number with reference to the displayed target telephone number. Alternatively, the wired telephone may automatically dials the target telephone number based on the displayed target telephone number. The user may call the target telephone through the wired telephone without transmitting the radio wave from the wireless mobile telephone.

Accordingly, the modified novel wire-less mobile telephone in the telephone-inoperable mode is capable of sending a call through the wired telephone in the radio-wave-transmission inhibited area to a target telephone located at another area.

Of course, the modified novel wire-less mobile telephone in the telephone-inoperable mode is also capable of the data processings, for example, displaying data on the display unit 5, wiring data into the memory 4, and reading and erasing the data from the memory 4 as well as browsing the informations stored in the memory 4 and hearing the voice informations stored in the memory 4.

In the above preferred embodiments, the descriptions have been made by taking the wireless mobile telephone as one typical example. The above descriptions are, of course, applicable to any other wire-less communication devices including mobile type and non-mobile type, and terminal devices and non-terminal devices. An example of the wire-less non-mobile type device is a wire-less communication device mounted on a movable vehicle. If the movable vehicle moves into the radio-wave-transmission-inhibited area, then it is necessary to switch the wire-less communication device into the radio-wave-transmission-inhibited mode, wherein the wire-less communication device is incapable of transmitting the radio-wave. If the wire-less communication device is used in a communication system free of any host device or station, the device is not the terminal device. Unidirectional, bidirectional or multi-directional communications may be made between or among plural wireless mobile or non-mobile devices. The above present invention is also applicable to these communication systems.

In the above embodiments, the display unit 5 and the memory 4 are integrated in the main circuit which is exclusive of the radio unit. It is, of course, possible to modify the above structure that the main circuit does not integrate the display and the memory, wherein the display and the memory are external devices electrically connectable to the main circuit of the wireless communication device.

The above descriptions in connection with the modified novel wireless mobile telephone are also applicable to data transmissions to the wired devices for data transmissions through any wire to any target device or system.

Consequently, the present invention essentially provides the wire-less communication device includes a main circuit capable of at least one operation of writing, reading and erasing data, and browsing informations, a radio unit having at least a first function block of transmitting a radio wave, and a power supply selector electrically coupled to the radio unit and the main circuit separately. In the first operational mode, the power supply selector supplies a power to both the radio unit and the main circuit, so as to place the radio unit and the main circuit in operable-state. In the second operational mode, the power supply selector inhibits a power supply to at least the first function block of the radio unit, so as to place at least the first function block of the radio unit in inoperable-state and place the main circuit in operable-state.

Although the invention has been described above in connection with several preferred embodiments therefor, it will be appreciated that those embodiments have been provided solely for illustrating the invention, and not in a limiting sense. Numerous modifications and substitutions of equivalent materials and techniques will be readily apparent to those skilled in the art after reading the present application, and all such modifications and substitutions are expressly understood to fall within the true scope and spirit of the appended claims.

What is claimed is:

1. A wire-less communication device including:
a main circuit capable of at least one operation of writing, reading and erasing data, and browsing and displaying informations as well hearing voice informations;
a radio unit having at least a first function block of transmitting a radio wave; and
a power supply selector electrically coupled to said radio unit and said main circuit separately,
wherein, in a first operational mode, said power supply selector supplies a power to both said radio unit and said main circuit, so as to place said radio unit and said main circuit in operable-state, and
wherein, in a second operational mode, said power supply selector inhibits a power supply to at least said first function block of said radio unit, so as to place at least said first function block of said radio unit in inoperable-state and place said main circuit in operable-state.

2. The wire-less communication device as claimed in claim 1, wherein said main circuit includes a control unit electrically coupled to said power supply selector for sending said power supply selector a first-mode control signal in said first operational mode so as to supply said power to both said radio unit and said main circuit, and sending said power supply selector a second-mode control signal in said second operational mode so as to inhibit the power supply to at least said first function block of said radio unit.

3. The wire-less communication device as claimed in claim 2, wherein said power supply selector is electrically connected through a first power supply line to at least said first function block of said radio unit, and also said power supply selector is electrically connected through a second power supply line to said main circuit, and in said first operational mode, said power supply selector supplies the power on both said first and second power supply lines and in said second operational mode, said power supply selector supplies the power on said second power supply line only.

4. The wire-less communication device as claimed in claim 1, wherein said radio unit further has a second function block for switching channels and a third function block for receiving the radio wave, and in said second operational mode, said power supply selector further inhibits the power supply to said second function block in addition to said first function block, so as to place at least both said first and second function blocks in inoperable state.

5. The wire-less communication device as claimed in claim 4, wherein said main circuit includes a control unit electrically coupled to said power supply selector for sending said power supply selector a first-mode control signal in said first operational mode so as to supply said power to both said radio unit and said main circuit, and sending said power supply selector a second-mode control signal in said second operational mode so as to inhibit the power supply to at least said first and second function blocks of said radio unit.

6. The wire-less communication device as claimed in claim 5, wherein said power supply selector is electrically connected through a first power supply line to at least said first and second function blocks of said radio unit, and also said power supply selector is electrically connected through a second power supply line to said main circuit, and in said first operational mode, said power supply selector supplies the power on both said first and second power supply lines and in said second operational mode, said power supply selector supplies the power on said second power supply line only.

7. The wire-less communication device as claimed in claim 4, wherein in said second operational mode, said power supply selector furthermore inhibits the power supply to said third function block in addition to said first and second function blocks, so as to place at least all said first, second and third function blocks in inoperable state.

8. The wire-less communication device as claimed in claim 7, wherein said main circuit includes a control unit electrically coupled to said power supply selector for sending said power supply selector a first-mode control signal in said first operational mode so as to supply said power to both said radio unit and said main circuit, and sending said power supply selector a second-mode control signal in said second operational mode so as to inhibit the power supply to all of said first, second and third function blocks of said radio unit.

9. The wire-less communication device as claimed in claim 8, wherein said power supply selector is electrically connected through a first power supply line to at least said first, second and third function blocks of said radio unit, and also said power supply selector is electrically connected through a second power supply line to said main circuit, and in said first operational mode, said power supply selector supplies the power on both said first and second power supply lines and in said second operational mode, said power supply selector supplies the power on said second power supply line only.

10. The wire-less communication device as claimed in claim 1, wherein said radio unit is electrically coupled to an antenna.

11. The wire-less communication device as claimed in claim 1, wherein said main circuit includes:
a control unit electrically coupled to said power supply selector for sending said power supply selector a first-mode control signal in said first operational mode so as to supply said power to both said radio unit and said main circuit, and sending said power supply selector a second-mode control signal in said second operational mode so as to inhibit the power supply to at least said first function block of said radio unit;
a memory electrically coupled to said control unit and also electrically connected through said second power supply line to said power supply selector, so that any access to said memory is permitted in both said first and second operational states; and
a display unit electrically coupled to said control unit and also electrically connected through said second power supply line to said power supply selector, so that any display of information and/or data is permitted in both said first and second operational states.

12. The wire-less communication device as claimed in claim 11, wherein said main circuit further includes:
a clock signal oscillator electrically coupled to said radio unit and said control unit for supplying a clock signal, and said clock signal oscillator being also connected through said second power supply line to said power supply selector for receiving the power from said power supply selector in both said first and second operational states.

13. The wire-less communication device as claimed in claim 11, further comprising a connector electrically coupled to said control unit, and said connector being electrically connectable with a wired external device for allowing data transmission through said connector to said wired external device.

14. The wire-less communication device as claimed in claim 1, further comprising a connector electrically coupled to said main circuit, and said connector being electrically connectable with a wired external device for allowing data transmission through said connector to said wired external device.

15. The wire-less communication device as claimed in claim 1, wherein said wire-less communication device comprises a wire-less mobile terminal having an antenna which is electrically coupled to said radio unit for transmitting a radio wave from said antenna only in said first operational mode.

16. The wire-less communication device as claimed in claim 15, wherein said wire-less mobile terminal comprises a wire-less mobile telephone.

17. The wire-less communication device as claimed in claim 16, further comprising a connector port electrically coupled to said main circuit, and said connector port being electrically connectable with a wired telephone for allowing data transmission through said connector port to said wired telephone.

18. The wire-less communication device as claimed in claim 17, wherein said data include at least a telephone number, so that said wired telephone displays said telephone number.

19. A wire-less communication device including:
a main circuit capable of at least one operation of writing, reading and erasing data, and browsing and displaying informations as well hearing voice informations;
a radio unit operable for at least transmitting and receiving a radio wave; and
a power supply selector electrically coupled to said radio unit and said main circuit separately,
wherein, in a first operational mode, said power supply selector supplies a power to both said radio unit and said main circuit, so as to place said radio unit and said main circuit in operable-state, and
wherein, in a second operational mode, said power supply selector inhibits a power supply to said radio unit, so as to place said radio unit in inoperable-state and place said main circuit in operable-state.

20. The wire-less communication device as claimed in claim 19, wherein said main circuit includes a control unit electrically coupled to said power supply selector for sending said power supply selector a first-mode control signal in said first operational mode so as to supply said power to both said radio unit and said main circuit, and sending said power supply selector a second-mode control signal in said second operational mode so as to inhibit the power supply to said radio unit.

21. The wire-less communication device as claimed in claim 19, wherein said radio unit is electrically coupled to an antenna.

22. The wire-less communication device as claimed in claim 19, wherein said main circuit includes:
a control unit electrically coupled to said power supply selector for sending said power supply selector a first-mode control signal in said first operational mode so as to supply said power to both said radio unit and said main circuit, and sending said power supply selector a second-mode control signal in said second operational mode so as to inhibit the power supply to said radio unit;
a memory electrically coupled to said control unit and also electrically connected through said second power supply line to said power supply selector, so that any access to said memory is permitted in both said first and second operational states; and
a display unit electrically coupled to said control unit and also electrically connected through said second power supply line to said power supply selector, so that any display of information and/or data is permitted in both said first and second operational states.

23. The wire-less communication device as claimed in claim 22, wherein said main circuit further includes:
a clock signal oscillator electrically coupled to said radio unit and said control unit for supplying a clock signal, and said clock signal oscillator being also connected through said second power supply line to said power supply selector for receiving the power from said power supply selector in both said first and second operational states.

24. The wire-less communication device as claimed in claim 20, further comprising a connector electrically coupled to said control unit, and said connector being electrically connectable with a wired external device for allowing data transmission through said connector to said wired external device.

25. The wire-less communication device as claimed in claim 19, further comprising a connector electrically coupled to said main circuit, and said connector being electrically connectable with a wired external device for allowing data transmission through said connector to said wired external device.

26. The wire-less communication device as claimed in claim 19, wherein said wire-less communication device comprises a wire-less mobile terminal having an antenna which is electrically coupled to said radio unit for transmitting a radio wave from said antenna only in said first operational mode.

27. The wire-less communication device as claimed in claim 26, wherein said wire-less mobile terminal comprises a wire-less mobile telephone.

28. The wire-less communication device as claimed in claim 27, further comprising a connector port electrically coupled to said main circuit, and said connector port being electrically connectable with a wired telephone for allowing data transmission through said connector port to said wired telephone.

29. The wire-less communication device as claimed in claim 28, wherein said data include at least a telephone number, so that said wired telephone displays said telephone number.

30. A wire-less mobile terminal device including:
at least a memory for storing data;
a display unit for displaying any data or information;
a control unit electrically coupled to said memory and said display unit;
a radio unit electrically coupled to an antenna for transmitting and receiving a radio-wave, and said radio unit being also electrically coupled to said control unit; and
a power supply selector electrically connected through a first power supply line to said radio unit and electrically connected through a second power supply line to said control unit, said display unit, and said memory, and also said power supply selector electrically connected through a control signal line to said control unit,
wherein, in a first operational mode, said control unit supplies a first-mode control signal to said power supply selector, so that said power supply selector supplies a power onto both said first and second power supply lines so as to place said radio unit, said control unit, said display unit, and said memory in operable-state, and
wherein, in a second operational mode, said control unit supplies a second-mode control signal to said power supply selector, so that said power supply selector supplies the power onto only said second power supply line so as to place said control unit, said display unit, and said memory in operable-state, and place said radio unit in inoperable-state.

31. The wire-less mobile terminal device as claimed in claim 30, further including:
a clock signal oscillator electrically coupled to said radio unit and said control unit for supplying a clock signal, and said clock signal oscillator being also connected through said second power supply line to said power supply selector for receiving the power from said power supply selector in both said first and second operational states.

32. The wire-less mobile terminal device as claimed in claim 30, further comprising a connector electrically coupled to said control unit, and said connector being electrically connectable with a wired external device for allowing data transmission through said connector to said wired external device.

33. The wire-less mobile terminal device as claimed in claim 30, wherein said wire-less mobile terminal comprises a wire-less mobile telephone.

34. The wire-less mobile terminal device as claimed in claim 33, further comprising a connector port electrically coupled to said control unit, and said connector port being electrically connectable with a wired telephone for allowing data transmission through said connector port to said wired telephone.

35. The wire-less mobile terminal device as claimed in claim 34, wherein said data include at least a telephone number, so that said wired telephone displays said telephone number.
